(19) United States
(12) Patent Application Publication
(10) Pub. No.: US 2002/0126089 A1
(43) Pub. Date: Sep. 12, 2002

(54) Remote control unit and system

(76) Inventor: Roelof Hamberg, Venlo (NL)

Correspondence Address: Corporate Patent Counsel, U S Philips Corporation, 580 White Plain Road, Tarrytown, NY, 10591, US

(21) Appl. No.: 09/507,402

(22) Filed: Feb. 18, 2000

(30) Foreign Application Priority Data
Feb. 26, 1999 (EP) 99200555.3

(51) Int. Cl. G09G 5/08

(52) U.S. Cl. 345/158

(57) ABSTRACT

A remote control system comprises a controllable apparatus (AP) and a remote control unit (RCU) for controlling an operation function of the apparatus (AP). The remote control unit (RCU) comprises user operable switches, and a sensor for detecting an angular movement around an axis of the remote control unit (RCU). The activated one of the user operable switches determines which specific operation function of the apparatus is controlled by the angular movement of the remote control unit (RCU).

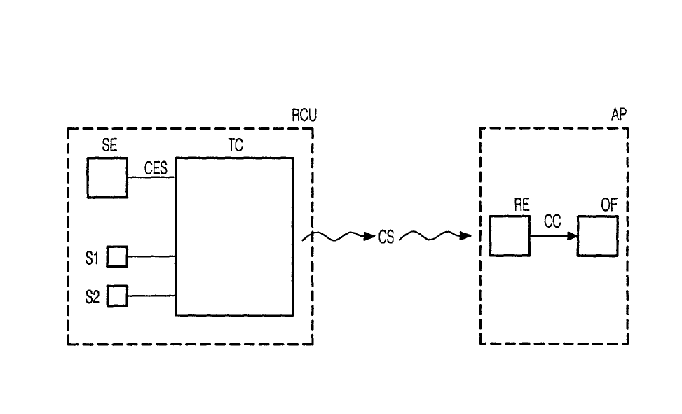

The invention relates to a remote control unit, a remote control system, and a remote control method.

EP-A-0625744 discloses a remote control system. Selective items arranged in a circle are displayed on a display screen of a television apparatus. A remote control transmitter comprises an angular velocity sensor mounted to detect an angular velocity about the longitudinal axis of the transmitter. When the transmitter is rotated around its longitudinal axis a control signal is transmitted to a receiver in the television apparatus and a cursor is moved over the selective items. To execute a specific function of the television apparatus, the transmitter is rotated until the cursor is positioned on the desired selective item representing this specific function, and then an execution switch is pressed.

It is, inter alia, an object of the invention to provide a remote control system which enables a more intuitive control of an operation function of the apparatus to be controlled.

To this end, a first aspect of the invention provides a remote control unit as claimed in claim 1. A second aspect of the invention provides a remote control system as claimed in claim 4. A third aspect of the invention provides a remote control method as claimed in claim 5. Advantageous embodiments are defined in the dependent claims.

The remote control system in accordance with the invention comprises a remote control unit which transmits a remote control signal for controlling a specific one of the operation functions of the apparatus to be controlled. By operation functions of the apparatus are meant all user-adjustable functions which influence the operation of the apparatus. Examples of operation functions are: all continuously or stepwise adjustable operation functions, such as volume, bass, treble, brightness, contrast, saturation, or channel or program up/down. The operation function is controlled directly by the angular movement of the remote control unit. For example, the volume is increased when the remote control unit is rotated around its longitudinal axis to the right, and the volume is decreased when the remote control unit is rotated around its longitudinal axis to the left. This resembles the operation of a volume knob on an audio amplifier and is thus a very intuitive way to control the volume. The user operable switches determine which specific operation function the angular movement should control. For example, the remote control unit may comprise two buttons for operating two associated switches. As long as a button is depressed and the corresponding switch is activated, the related operation function is controlled by the angular movement of the remote control unit around its axis. For example, when the first button is depressed the volume is controlled, when the other button is depressed the program selection is activated. In this latter case, a program number is increased when the remote control unit is rotated around its axis to the right, and the program number is decreased when the remote control unit is rotated around its axis to the left. The codes transmitted by the remote control unit may be specific for the function to be controlled. For example, when the volume button is depressed a volume up code is transmitted when the remote control unit is rotated around its axis to the right. Alternatively, it is also possible to send a code that the volume has to be controlled in response to pressing the volume button, and codes representing the angular movement, which latter codes are independent of the button pressed.

In an embodiment of the invention as claimed in claim 2, the angular movement of the remote control unit only controls a specific operation function during the time the corresponding user operable switch is activated. This is a very user intuitive control.

In an embodiment of the invention as claimed in claim 3, an adjustment value of a specific operation function is controlled. For example, the contrast is controlled by a value of a control voltage or current.

These and other aspects of the invention will be apparent from and elucidated with reference to the embodiments described hereinafter.

The sole drawing shows a remote control system according to the invention. The remote control system comprises a remote control unit RCU and a controllable apparatus AP. The remote control unit RCU comprises a sensor SE, a plurality of user operable switches S1, S2, and a transmitter circuit TC. The sensor SE is of a type suitable for detecting an angular movement around an axis of the remote control unit RCU. Preferably, the remote control unit RCU is shaped so that it can be easily held in a hand in such a way that its axis is in line with the arm of a person carrying the remote control unit RCU and a rotation of the wrist is a rotation around the axis. The output signal CES of the sensor SE is an indication of the angular movement. The transmitter circuit TC receives the output signal CES and detects the status of the user operable switches S1, S2 to supply a remote control signal CS to the controllable apparatus AP. Preferably, the remote control signal CS is transmitted to a receiver circuit RE of the controllable apparatus AP by air using infrared or radio techniques. The transmitter circuit TC may comprise an amplifier circuit for amplifying the output signal CES of the sensor SE, an analog to digital converter for converting the amplified sensor signal into digital data, and a microcomputer receiving the digital data. The microprocessor detects whether one of the user-operable switches S1, S2 is activated to generate the remote control signal CS in accordance with the user-operable switch S1, S2 activated and the detected angular movement around the axis of the remote control unit RCU. For example, the control signal CS may comprise words composed by bits. When the microprocessor detects that one of the user operable switches S1, S2 is activated, it is possible to first generate a specific word indicating the specific operation function corresponding to the activated user-operable switch S1, S2, and then generate words indicating the angular movement of the remote control unit RCU. The words indicating the angular movement are independent of which one of the user-operable switches S1, S2 is activated. Alternatively, it is possible that the microprocessor generates words for controlling the specific function as selected by the activated user-operable switch S1, S2 in accordance with the angular movement. For example, when the brightness switch is activated by depressing the associated button, a brightness-up code is transmitted when the remote control unit is rotated around its axis to the right. It is possible to activate more than one user operable switch S1, S2 at the same time to control a further operation function.

The controllable apparatus AP comprises a receiver circuit RE and an operation function circuit OF. The receiver circuit RE receives the remote control signal CS to supply control commands CC to control the operation function circuit OF. For example, when the controllable apparatus AP is a picture display apparatus, the operation function circuit OF may be a contrast control circuit. The receiver circuit RE may comprise a circuit for decoding the transmitted remote control signal CS. A receiver microcomputer receives the decoded control signal to generate the control commands CC. For example, when the receiver microcomputer receives a contrast-up word, the control command CC adapts a register value in an integrated circuit for processing the video information such that the contrast is increased. Alternatively, the receiver microcomputer may generate an analog voltage for controlling the contrast.

It should be noted that the above-mentioned embodiments illustrate rather than limit the invention, and that those skilled in the art will be able to design many alternative embodiments without departing from the scope of the appended claims. For example, dedicated analog and/or digital circuits may be used instead of the microcomputers.

The control signal may be coded in any known way and its transmission may be modulated in any way. In a preferred embodiment, codes (digital words) are transmitted, which are specific for the operation to be controlled. For example, in the case of infrared transmission, during an on-time of the bits of the words infrared light pulses with a predetermined repetition frequency are transmitted, during the off-time of the bits no infrared light is generated. If only two operation functions are to be controlled, the transmitter could send four different frequencies. A first frequency indicates an action causing a decrease of the value of a first operation function (volume down), a second frequency indicates an action heading to an increase of the value of the first operation function (volume up), a third frequency indicates an action heading to a to decrease of the value of a second operation function (program selection down), a fourth frequency indicates an action heading to an increase of the value of the second operation function (program selection up).

It is possible to provide a feedback to the person using the remote control unit RCU to indicate the effect of the rotation of the remote control unit RCU. This feedback may be a graphical representation displayed on the controllable apparatus AP.

In the claims, any reference signs placed between parentheses shall not be construed as limiting the claim. The word “comprising” does not exclude the presence of elements or steps other than those listed in a claim. The invention can be implemented by means of hardware comprising several distinct elements, and by means of a suitably programmed computer. In the device claim enumerating several means, several of these means can be embodied by one and the same item of hardware.

1. A remote control unit (RCU) for controlling an apparatus (AP), which remote control unit (RCU) comprises:
a sensor (SE) for detecting an angular movement about an axis of the remote control unit (RCU),
user operable switches (S1, S2), and
a transmitter circuit (TC) for transmitting a remote control signal (CS) to the apparatus (AP) based on an output signal (CES) from the sensor (SE) and a status of the user operable switches (S1, S2),
characterized in that the transmitter circuit (TC) is adapted to supply the remote control signal (CS) for controlling a specific operation function (OF) of the apparatus (AP) in agreement with the angular movement, the specific operation function (OF) being selectable by selectively activating the user operable switches (S1, S2).

2. A remote control unit (RCU) as claimed in claim 1, characterized in that the transmitter circuit (TC) is adapted to supply the remote control signal (CS) for controlling the specific operation function (OF) in agreement with the angular movement as long as a corresponding one of the user operable switches (S1, S2) is activated.

3. A remote control unit (RCU) as claimed in claim 1, characterized in that the transmitter circuit (TC) is adapted to supply the remote control signal (CS) for controlling an adjustment value of the specific operation function (OF).

4. A remote control system comprising a controllable apparatus (AP), and a remote control unit (RCU) for controlling a function of the controllable apparatus (AP), the remote control unit (RCU) comprising:
a sensor (SE) for detecting an angular movement about an axis of the remote control unit (RCU),
user-operable switches (S1, S2), and
a transmitter circuit (TC) transmitting a remote control signal (CS) to the controllable apparatus (AP) based on an output signal (CES) from the sensor (SE) and a status of the user operable switches (S1, S2),
the controllable apparatus (AP) comprising:
a receiver circuit (RE) for receiving the control signal (CS) to control the function of the controllable apparatus (AP),
characterized in that the transmitter circuit (TC) is adapted to supply the remote control signal (CS) for controlling a specific operation function (OF) of the controllable apparatus (AP) in agreement with the angular movement, the specific operation function (OF) being selected by selectively activating the user-operable switches (S1, S2).

5. A remote control method using a remote control unit (RCU) for controlling an apparatus (AP), the remote control method comprising the steps of:
detecting (SE) an angular movement about an axis of the remote control unit,
receiving (TC) user input from user operable switches (S1, S2) of the remote control unit (RCU), and
transmitting (TC) a remote control signal (CS) to the apparatus (AP), which signal is determined by the angular movement and a status of the user operable switches (S1, S2),
characterized in that the step of transmitting (TC) is adapted to supply the remote control signal (CS) for controlling a specific operation function (OF) of the apparatus (AP) in agreement with the angular movement of the remote control unit (RCU), the specific operation function (OF) being indicated by selectively activating the user operable switches (S1, S2).
